(19) United States
(12) Patent Application Publication
(10) Pub. No.: US 2005/0155781 A1
(43) Pub. Date: Jul. 21, 2005

(54) Slidable motherboard tray structure

(76) Inventors: Chih-Wei Kao, Taoyuan City (TW); Cheng-Cheng Lee, Taipei (TW); Chih-Wei Lee, Taoyuan City (TW)

Correspondence Address: RABIN & BERDO, P.C., Suite 500, 1101 14 Street, N.W., Washington, DC, 20005, US

(21) Appl. No.: 10/909,420

(22) Filed: Aug. 3, 2004

(30) Foreign Application Priority Data
Jan. 20, 2004 (TW) 93201172

(51) Int. Cl. H02G 3/08

(52) U.S. Cl. 174/50

(57) ABSTRACT

A slidable motherboard tray structure is disclosed for holding and moving a motherboard. The slidable motherboard tray structure is featured in using leverage principle to design handle elements pivotally connected to a motherboard tray housing, so that pushing force is generated between the respective handle elements and supporting elements, thereby enabling the motherboard located in the motherboard tray housing to slide to a predetermined position, thus achieving the purposed of automatically positioning and saving force.

### FIELD OF THE INVENTION

The present invention relates to a slidable motherboard tray structure, and more particularly, to the motherboard tray structure using leverage principle to position a motherboard tray by sliding.

### BACKGROUND OF THE INVENTION

It is more and more popular with users to use a motherboard tray forholding and moving a motherboard. With the daily increase of various applications, more and more electronic elements and modules are installed on a motherboard, and the weight of the motherboard is accordingly increased. Since the motherboard becomes heavy, a conventional way of positioning the motherboard tray (holding the motherboard) directly by hands generally takes a lot of time and effort, and it is very difficult to move the motherboard accurately to an appropriate position thereby. Therefore, the conventional way of positioning the motherboard tray directly by hands cannot effectively meet the users' requirements.

Hence, there is a need to develop a slidable motherboard tray structure for effectively positioning a motherboard tray by sliding, and saving time and effort for positioning the motherboard tray, thereby overcoming the disadvantages of using the conventional way of positioning the motherboard tray directly by hands.

### SUMMARY OF THE INVENTION

It is an object of the present invention to provide a slidable motherboard tray structure for positioning a motherboard tray housing by sliding via pushing force (torque) generated between the handle elements and the supporting elements of the motherboard tray housing, thereby achieving the purpose of automatic positioning and labor saving.

According to the aforementioned objects of the present invention, the present invention provides a slidable motherboard tray structure for holding and moving a motherboard.

According to a preferred embodiment of the present invention, the slidable motherboard tray structure comprises a motherboard tray housing, a pair of supporting elements, and a pair of handle elements. The supporting elements are installed respectively on two opposite sides of the motherboard tray housing, and each of the handle element has an arc-shaped opening used for receiving the corresponding supporting element, wherein there is a distance between a force-acting end of each of the handle elements and the corresponding supporting element, and the arc-shaped opening of each of the handle elements further has a sidewall, and, when each of the handle elements is rotated with an angle, the sidewall of the arc-shaped opening resists each of the supporting elements to generate a pushing force used for moving the motherboard tray housing;

Further, each of the handle elements has a striped-shape notch, and a rotation-stopping element is installed on each of the two opposite sides of the motherboard tray housing, so that the rotation-stopping element is engaged with the stripe-shaped notch correspondingly after the handle element has been rotated with an angle.

Further, the slidable motherboard tray structure comprises a pair of fixing elements used for pivotally connecting the handle elements respectively to the two opposite sides of the motherboard tray housing.

Further, the rotation-stopping elements are installed in rotation-adjusting openings, and each of the rotation-adjusting openings has an adjusting groove and two adjusting holes located on both ends of the adjusting groove.

Hence, with the application of the present invention, a motherboard tray housing can be briefly positioned by sliding, thereby greatly saving the time and effort for positioning the motherboard tray.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an explosive schematic view showing a slidable motherboard tray structure of the present invention;

FIGS. 2A and 2B are 3-D schematic diagrams respectively showing the slidable mother board structure disposed in a computer chassis before and after positioning;

FIG. 2C is an enlarged view of detail A shown in FIG. 2A; and

FIG. 2D is an enlarged view of detail B shown in FIG. 2A.

### DETAILED DESCRIPTION OF THE PREFERRED EMBODIMENT

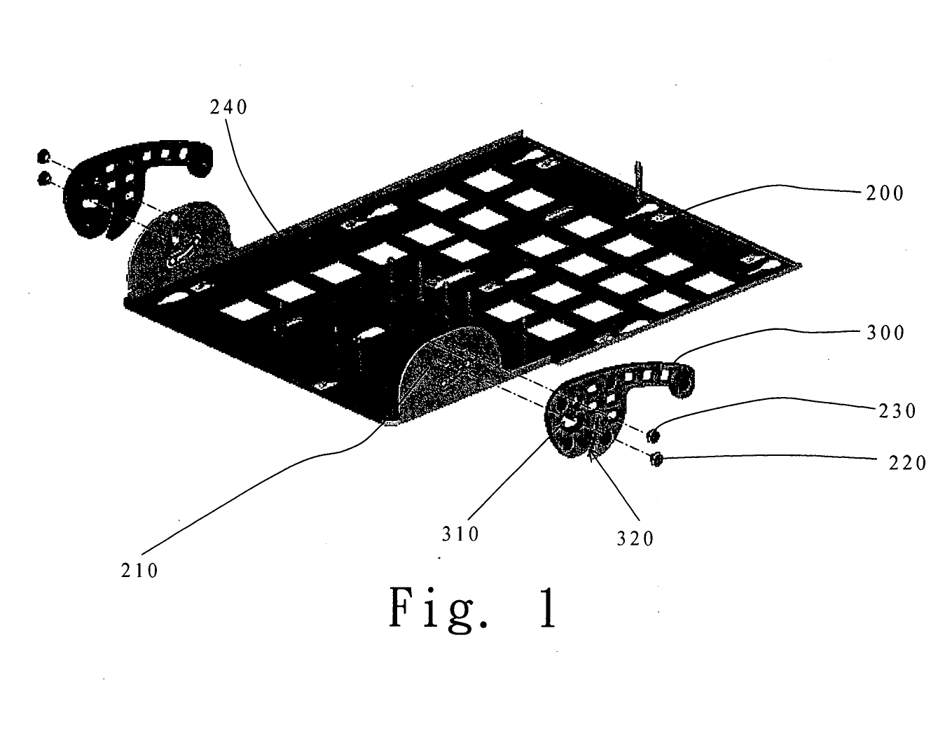

Referring to FIG. 1, FIG. 1 is an explosive schematic view showing a slidable motherboard tray structure of the present invention. The slidable motherboard tray structure of the present invention is composed of a motherboard tray housing 200, a pair of supporting elements 220, a pair of fixing elements 230, and a pair of handle elements 300. The supporting elements 220 are installed respectively on two opposite sides 210 of the motherboard tray housing 200, and the fixing elements 230 are used to pivotally connect the handle elements 300 respectively on the two opposite sides 210 of the motherboard tray housing 200. The handle elements 300 have respective arc-shaped openings 310 in which the supporting elements 200 are received. When the handle elements 300 are rotated, the supporting elements 200 can move freely within the arc-shaped opening correspondingly. Further, when the handle elements 300 are rotated with a certain angle, a pushing force will be generated via the sidewalls of the arc-shaped openings 310 resisting the supporting elements 220 correspondingly, so as to move the motherboard tray housing 200 in which a motherboard 110 is held.

Further, the handle elements 300 have respective stripe-shaped notches 320, and rotation-stopping elements 240 are installed respectively on the two opposite sides 210 of the motherboard tray housing 200. When the handle elements 300 have been rotated with a certain angle, the rotation-stopping elements 240 can be engaged with the respective stripe-shaped notches 320, so as to lock the handle elements 300 respectively on the two sides 210 of the motherboard tray housing 200. With the design of matching the shapes of the arc-shaped openings 310 with the positions of the rotation-stopping elements 240, the motherboard tray housing 200 can be slid for a predetermined distance by rotating the handle elements 300 with a certain angle, thereby achieving the purpose of automatically positioning the motherboard tray housing 200.

Hereinafter, the operation procedure of the slidable motherboard tray structure is described according to the present invention:

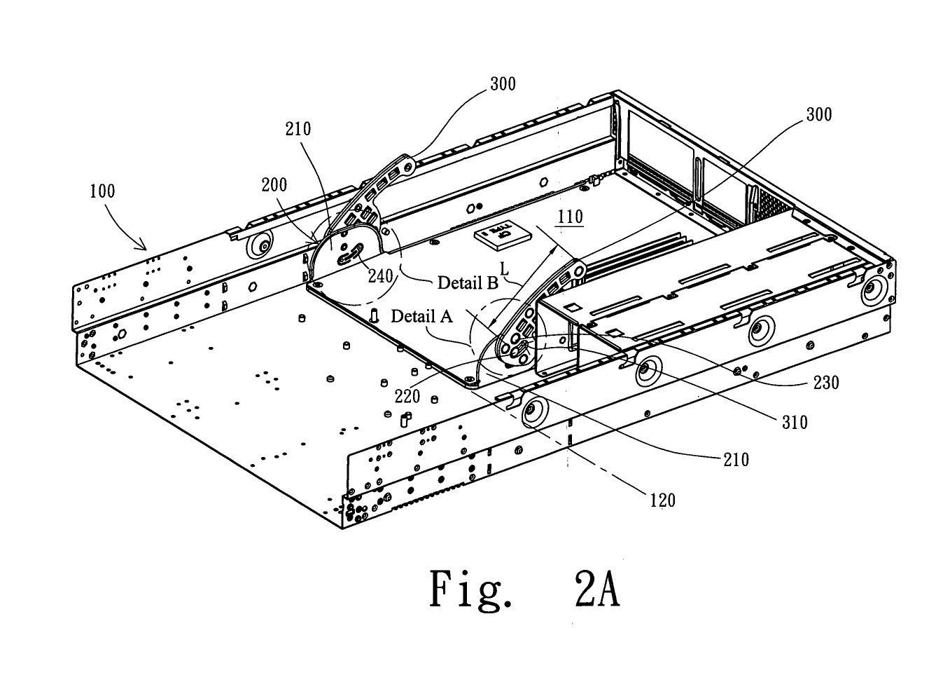

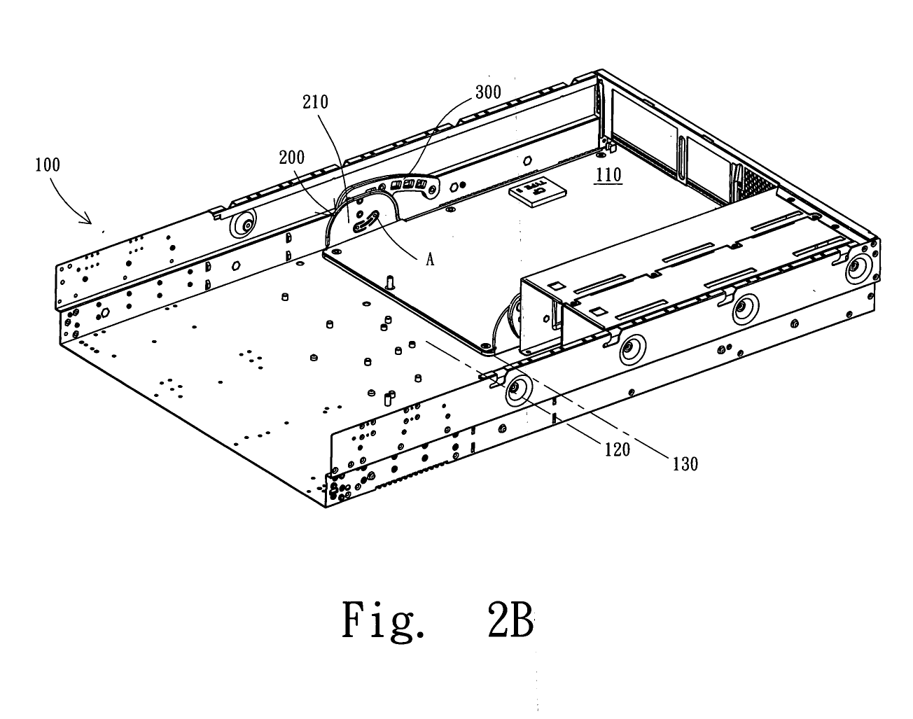

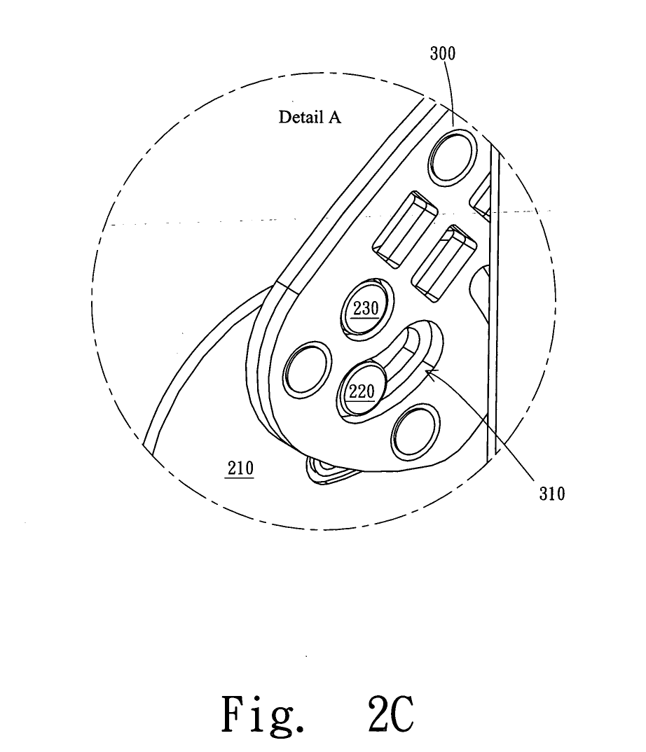

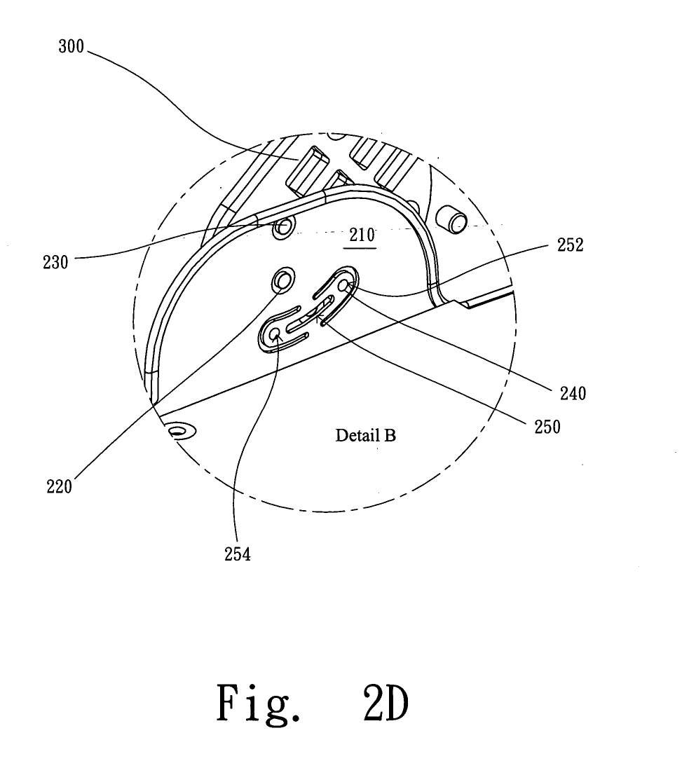

Referring to FIG. 2A to FIG. 2D, FIGS. 2A and 2B are 3-D schematic diagrams respectively showing the slidable motherboard structure disposed in a computer chassis before and after positioning; FIG. 2C is an enlarged view of detail A shown in FIG. 2A; and FIG. 2D is an enlarged view of detail B shown in FIG. 2A. Such as shown in FIG. 2A, before positioning, the motherboard tray housing 200 is located at a first position 120. When the handle elements 300 are rotated clockwise, the sidewall of the arc-shaped opening 310 shown in FIG. 2C will exert a pushing force to the supporting elements 220, thus enabling the supporting elements 220 to carry the motherboard tray housing 200 to an appropriate position, such as a second position 130 shown in FIG. 2B.

Thereafter, the stripe-shaped notch 320 (as shown in FIG. 1) is engaged with the rotation-stopping element 240 (as shown in FIG. 2D) so as to fix the handle elements 300. The position of the rotation-stopping elements 240 can determine the degrees of rotation angle for the handle elements, thereby determining the distance for the motherboard tray housing 200 to be moved, thus achieving the purpose of automatic positioning. Such as shown in FIG. 2D, the rotation-stopping elements 240 are located in rotation-adjusting openings (not labeled), and each of the rotation-adjusting openings is composed of an adjusting groove 250, and two adjusting holes 252 and 254 located on both ends of the adjusting groove 250, wherein the adjusting groove 250 is an arc shape. When the rotation-stopping elements 240 are installed in the adjusting holes 252, the value of the angle that the handle elements 300 can rotate is smaller, and accordingly, the sliding distance that the motherboard tray housing 200 to be carried is also shorter. When the rotation-stopping elements 240 are installed in the adjusting holes 254, the value of the angle that the handle elements 300 can rotate is larger, and accordingly, the sliding distance that the motherboard tray housing 200 to be carried is longer. When the rotation-stopping elements 240 are installed in the adjusting grooves 250, with the rotation-stopping elements 240 located more closely to the adjusting holes 254, the value of the angle that the handle elements 300 can rotate is larger, and accordingly, the sliding distance that the motherboard tray housing 200 to be carried is also longer.

It is worthy to be noted that there is a distance L (as shown in FIG. 2A) between the force-acting end of the handle element 300 and the corresponding-supporting element 220. The longer the distance L is, the bigger the torque is generated thereby, and accordingly, the force required to move the motherboard tray housing 200 is smaller, thus achieving the purpose of labor saving.

Further, the handle elements 300 and the supporting elements 220 can be located on one end of the motherboard tray housing or any other appropriate positions thereon. The aforementioned structures of the handle elements 300, the supporting elements 220, and the rotation-adjusting openings (250, 252, 254) are merely stated as examples for explanation, so are the force reaction relationship and direction, and thus the present invention is not limited thereto. After proper adjustment, the present invention also can be applied in rotating the handle elements to move the motherboard tray housing toward to the other direction, such as to move the motherboard tray housing from the second position 130 to the first position 120.

Hence, the present invention is applied by using leverage principle to design the handle elements pivotally connected to the motherboard tray housing, thereby enabling the motherboard tray to side to an appropriate position via a pushing force (torque) generated between the handle elements and the supporting elements, thus achieving the purposes of automatic positioning and labor saving to overcome the disadvantages of using the conventional way of positioning the motherboard tray directly by hands.

It can be known from the aforementioned preferred embodiment of the present invention, the present invention has an advantage of effectively positioning a motherboard tray by sliding, thus greatly saving a lot of time and effort for positioning the motherboard tray. Therefore, the present invention has considerably high industrial application value.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A slidable motherboard tray structure, comprising:
a motherboard tray housing;
a supporting element, installed on a side of said motherboard tray housing; and
a handle element, having an arc-shaped opening used for receiving said supporting element correspondingly, wherein there is a distance between said supporting element and a force-acting end of said handle element, and said arc-shaped opening of said handle element further has a sidewall, and, when said handle element is rotated with an angle, said sidewall of said arc-shaped opening of said handle element resists said supporting element to generate a pushing force used for moving said motherboard tray housing.

2. The slidable motherboard tray structure of claim 1, wherein a motherboard is disposed on a bottom of said motherboard tray housing.

3. The slidable motherboard tray structure of claim 1, wherein said slidable motherboard tray structure is located in a computer chassis.

4. The slidable motherboard tray structure of claim 1, wherein said handle element and said supporting element both are located on one end of said motherboard tray housing.

5. The slidable motherboard tray structure of claim 4, wherein said pushing force provides a rotation torque to make said motherboard tray housing slide.

6. The slidable motherboard tray structure of claim 4, wherein the direction of said pushing force is different from the direction of said motherboard tray housing sliding.

7. The slidable motherboard tray structure of claim 1, wherein said handle element has a stripe-shaped notch, and a rotation-stopping element is installed on said side of said motherboard tray housing, so that said rotation-stopping element is engaged with said stripe-shaped notch after said handle element has been rotated with said angle.

8. The slidable motherboard tray structure of claim 7, wherein said rotation-stopping element is installed in a rotation-adjusting opening.

9. The slidable motherboard tray structure of claim 8, wherein said rotation-adjusting opening includes a adjusting groove and two adjusting holes located on both ends of said adjusting groove.

10. The slidable motherboard tray structure of claim 9, wherein said adjusting groove is formed in an arc-shaped shape.

11. The slidable motherboard tray structure of claim 1, further comprising a fixing element, used for pivotally connecting said handle element to said side of said motherboard tray housing.

12. A slidable motherboard tray structure, comprising:
a motherboard tray housing;
a pair of supporting elements, respectively installed on two opposite sides of said motherboard tray housing;
a pair of handle elements, each of said handle elements having an arc-shaped opening used for receiving each of said supporting elements correspondingly, wherein there is a distance between each of said supporting elements and a force-acting end of each of said handle elements, and the arc-shaped opening of each of the handle elements further has a sidewall. When the handle element is rotated with an angle, the sidewall of the arc-shaped opening resists the corresponding supporting element to generate a pushing force used for moving the motherboard tray housing;
a pair of fixing elements, used for pivotally connecting said handle elements respectively to said two opposite sides of said motherboard tray housing; and
a pair of rotation-stopping elements, respectively installed on said two opposite sides of said motherboard tray housing, wherein each of said handle elements has a stripe-shaped notch, so that each of said rotation-stopping elements is engaged with said stripe-shaped notch correspondingly after each of said handle elements has been rotated with said angle.

13. The slidable motherboard tray structure of claim 12, wherein a motherboard is disposed on a bottom of said motherboard tray housing.

14. The slidable motherboard tray structure of claim 12, wherein said slidable motherboard tray structure is located in a computer chassis.

15. The slidable motherboard tray structure of claim 12, wherein said handle elements and said supporting elements all are located on one end of said motherboard tray housing.

16. The slidable motherboard tray structure of claim 15, wherein said pushing force provides a rotation torque to make said motherboard tray housing slide.

17. The slidable motherboard tray structure of claim 15, wherein the direction of said pushing force is different from the direction of said motherboard tray housing sliding.

18. The slidable motherboard tray structure of claim 12, wherein each of said rotation-stopping element is installed in a rotation-adjusting opening.

19. The slidable motherboard tray structure of claim 12, wherein said rotation-adjusting opening has a adjusting groove and two adjusting holes located on both ends of said adjusting groove.

20. The slidable motherboard tray structure of claim 19, wherein said adjusting groove is formed in an arc shape.
